(19) United States
(12) Patent Application Publication
(10) Pub. No.: US 2018/0052958 A1
(43) Pub. Date: Feb. 22, 2018

(54) PATIENT-OWNED ELECTRONIC HEALTH RECORDS SYSTEM AND METHOD

(71) Applicant: MINDSET MEDICAL, LLC, SCOTTSDALE, AZ (US)

(72) Inventors: NEIL CRAWFORD, CHANDLER, AZ (US); MITCH FOSTER, SCOTTSDALE, AZ (US); MICHAEL BARTELME, FORT COLLINS, CO (US); NICHOLAS THEODORE, RUXTON, MD (US)

(21) Appl. No.: 15/683,288

(22) Filed: Aug. 22, 2017

Related U.S. Application Data
(60) Provisional application No. 62/377,860, filed on Aug. 22, 2016.

(51) Int. Cl. G06F 19/00; G06F 21/62

(52) U.S. Cl. CPC G06F 19/322; G06F 19/3406; G06F 21/6245

(57) ABSTRACT

Embodiments of the invention provide a personal digital health portfolio system including a computer system coupled to a source of patient medical records or patient data with accessibility controlled by a secure authenticator structured for an uploader, downloader or reviewer of the patient medical records or patient data. An application programming interface (API) in data communication with a processor of the computer system can upload, download, or enable access of patient medical records or patient data stored on a non-transitory computer-readable storage medium. An interface of the source of patient medical records or patient data can read and transfer the patient medical records or patient data under control of a second entity via the API. A digital gateway is coupled to provide secure distributed access of the patient medical records or patient data stored from the non-transitory computer-readable storage medium to a doctor, pharmacy, health service, or insurance company.

### RELATED APPLICATIONS

This application claims priority to U.S. provisional application Ser. No. 62/377,860, filed on Aug. 22, 2016, the entire contents of which are incorporated herein by reference.

### BACKGROUND

Patient medical records are routinely created, accessed, and/or updated by doctors, nurses, and other medical professionals during or soon after the delivery of a medical service or procedure. These records can enable a medical provider to review current medical history, update information related to ongoing delivery of medical care, access a patient's medical past records, and follow a patient's progress. In today's mobile society, a patient may consult with more than one doctor or specialist due to travel or relocation. Further, due to the complexity of today's medical care, patients are often reviewed by more than one doctor or specialist, and may receive specific types of medical care at one than one clinic, hospital, or other medical institution. The process of transfer of medical records between medical providers and institutions can be slow, and is often not adequate during emergency care.

There may be several options for medicines to treat certain diseases, with different medicines being more or less suitable for treating different patients, or providing varying amounts of relief in the same patient under different circumstances. For this reason, and because patients may be taking numerous medications for more than one disease, there can be situations where a patient has several different medications requiring different dosages and/or dosing schedules, or are taken as needed when certain circumstances and symptoms arise. It can be difficult for the patient to understand or remember which medicines to use to treat different symptoms, and which medicines can be combined.

Thus, there is a need for a tool that allows patients to rapidly access and control communication of their entire medical history. This kind of tool would enable a patient to rapidly transfer or communicate any or all contents of the medical history to another doctor or other healthcare worker to quickly access and review critical medical data, review current medical history, update information related to ongoing delivery of medical care, access a patient's medical past records, and follow the patient's progress. Further, a tool is needed that simplifies the patient's understanding of any medical conditions and treatment options. Currently when leaving the emergency room, the patient often receives a folder of printed materials with instructions on follow-up, education about medication, symptoms to watch for, and other information. The information may also assist the patient in understanding their medical condition, and aid the delivery of any medicines or procedures. However, such folders typically contain an overwhelming amount of information to manage and digest.

### SUMMARY

Some embodiments include a personal digital health portfolio system comprising a computer system including at least one processor, and at least one coupled source of patient medical records or patient data. In some embodiments, the computer system can include at least one secure authenticator that is structured to securely authenticate identity of at least one first entity as an uploader, downloader or reviewer of the patient medical records or patient data. Further, some embodiments include at least one non-transitory computer-readable storage medium in data communication with the processor that can securely store and exchange data related to the content of or the accessibility of the patient medical records or patient data. Some embodiments include an application programming interface (API) in data communication with the processor including steps executable by the processor for uploading, downloading, or enabling accessing of patient medical records or patient data stored on the at least one non-transitory computer-readable storage medium. Further, some embodiments include an interface of the source of patient medical records or patient data that is configured to read and transfer the patient medical records or patient data under control of a second entity via the application programming interface (API). Some embodiments include a digital gateway coupled to provide distributed access of the patient medical records or patient data stored from the at least one non-transitory computer-readable storage medium to at least one doctor, pharmacy, health service, or insurance company. In some embodiments, the distributed access is maintained, controlled or provided by the first or second entity for specific components of patient medical records or patient data that form the personal digital health portfolio.

In some embodiments, the interface of the source is a hardware interface. In some embodiments, the hardware interface comprises a main housing including an upper head at one end extending from a support, and a base at an opposite end extending from the support. In some further embodiments, the main housing includes an optical reader, scanner or camera. In some other embodiments of the invention, the main housing includes a wireless receiver configured to enable wireless transfer of instructions or data from a smartphone or tablet. In some embodiments, the wireless receiver comprises at least one of a near-field communication receiver, an RFID receiver, a WiFi receiver, a Bluetooth®, and a Bluetooth® Low Energy (BLE) receiver.

In some embodiments of the invention, the interface comprises at least one information or data recorder that can assist reading or recording of at least one record of at least one medical practitioner relating to the at least one patient, to at least one digital file, where at least a portion of the digital file is transferable through the digital gateway. In some embodiments, at least one information or data recorder can read or record information obtained by from a medical practitioner in the physical presence of at least one patient, a medical practitioner not in the physical presence of the patient, at least one patient in the presence of at least one medical practitioner, the patient not in the presence of at least one medical practitioner, or substantially simultaneously information from the patient and the medical practitioner.

In some embodiments, the first entity and/or the second entity is the patient. In some embodiments, the first entity and/or the second entity is a doctor or insurance provider. In some embodiments, at least some of the steps comprise steps of at least one application program interface (API) executed on a smartphone or tablet. In some embodiments, the smartphone or tablet comprises the interface. In some embodiments, the interface can read data from the smartphone or tablet. In some embodiments, the interface includes an optical reader configured to enable imaging of a screen of the smartphone or tablet. In some embodiments, the interface includes a wireless receiver configured to enable wireless transfer of instructions or data from the smartphone or tablet. In other embodiments, the wireless receiver comprises at least one of a near-field communication receiver, an RFID receiver, a WiFi receiver, a Bluetooth®, and a Bluetooth® Low Energy (BLE) receiver. In some embodiments, the interfaces supports or controls a secure login to at least one account associated with the patient of at least one medical practitioner or medical provider on an intranet or internet website.

In some further embodiments, the interface comprises a device measuring one or more health or medical parameters directly from the patient. In some embodiments, the device can comprise a blood-pressure monitor or cuff, heart-rate monitor, accelerometer, a wearable exercise tracker, a body temperature tracker, a patient weight tracker, a patient height tracker, an electrocardiogram tracker, an electroencephalogram tracker, an electromyogram tracker, a blood oxygenation tracker, and a blood glucose level tracker.

In some embodiments, the patient medical records or patient data can comprise insurance identification information and eligibility, patient demographic information, patient name and address, patient medical history, patient family medical history, permission and release forms, list of drug and environmental allergies and sensitivities, healthcare directives and/or living will instructions, provider observational or diagnostic notes including subjective, objective, assessment, and/or plan notes, and prescriptions including current, pending, and past with an associated security tag, lab test results including blood tests, gait tests, EEG, ECG, and/or respiration measurement, fitness records including heart-rate, weight, body fat, number of daily steps, sleep cycle, diet, and medical images including CT scans, MRI scans, x-rays, ultrasound, and questionnaires or surveys from providers, insurance, or other parties related to subjective measures of patient satisfaction including at least one of patient satisfaction with the personal interactions at the doctor's office and perceived effectiveness of the prescribed treatment.

### DESCRIPTION OF THE DRAWINGS

FIG. 1A illustrates an all-in-one device according to some embodiments of the invention.

FIG. 1B illustrates a wrist-mounted all-in-one device of FIG. 1A according to some embodiments of the invention.

FIG. 1C illustrates a wrist-mounted all-in-one device with a blood-pressure cuff according to some embodiments of the invention.

FIG. 2 shows a block diagram of a system implementing a patient-owned electronic health records process according to some embodiments of the invention.

FIG. 3A shows a front perspective view of a hardware interface unit of a patient-owned electronic health records process PDHP system and method according to some embodiments of the invention.

FIG. 3B shows a top-front perspective view of a hardware interface unit of a patient-owned electronic health records process PDHP system and method according to some embodiments of the invention.

FIG. 3C shows a front view of a hardware interface unit of a patient-owned electronic health records process PDHP system and method according to some embodiments of the invention.

FIG. 3D shows a side view of a hardware interface unit of a patient-owned electronic health records process PDHP system and method according to some embodiments of the invention.

FIG. 4 illustrates a computer system 400 configured for operating and processing a patient-owned electronic health records process according to some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

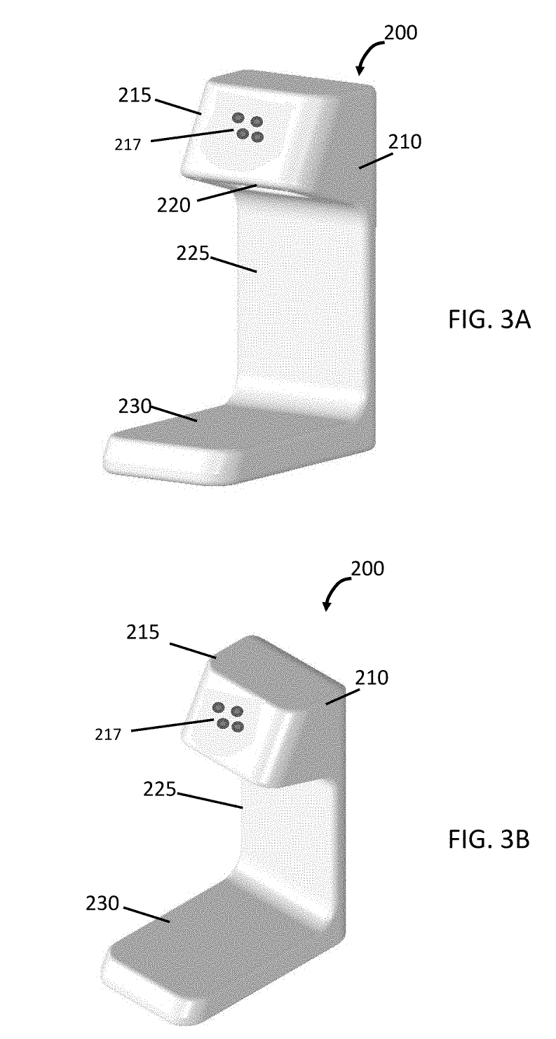

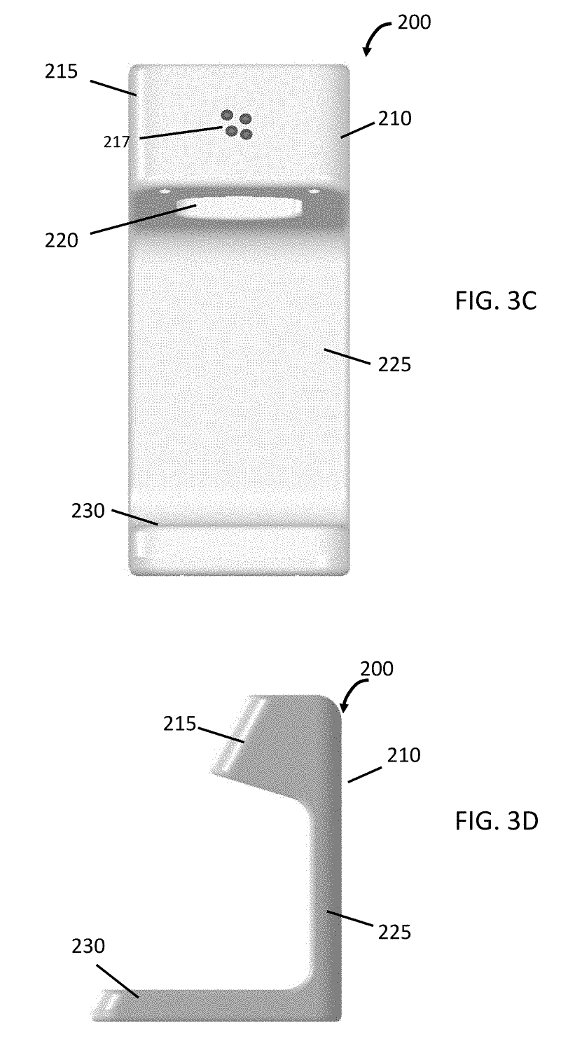

Some embodiments include a personal digital health portfolio (“PDHP”) system and method that can store and retrieve health records. In some embodiments, the PDHP system and method can include several components, including, but not limited to, 1) a database stored in a secure cloud storage, and/or 2) a patient smartphone or tablet application that can allow the patient to enter and retrieve records as well as to control settings allowing doctors, pharmacies and other health services to access certain components of the stored records, and/or 3) a patient web-based application with many of the same features as the smartphone or tablet application that can allow an alternative pathway to access data, and/or 4) a provider smartphone or tablet application that can allow healthcare providers to request certain records from the patient and to provide messaging notification to the patient via their smartphone and/or tablet/email or other means, and/or 5) a provider web-based application with many of the same features as the provider smartphone or tablet application that can allow an alternate pathway to requesting patient data, sending patient data, and sending notifications to other staff or the patient, and/or 6) a hardware interface unit (e.g., such as interface unit 200 shown in FIGS. 3A-3D that provides a means for securely logging in or out of the system, sending data to providers, receiving data from providers, or initiating certain communications.

In some embodiments, the database of the PDHP system and method can store one or more personal digital health records in a secure cloud-based storage space, accessible only with appropriate clearance. For example, some embodiments include a cloud-based database such as Amazon Cloud Services or other conventional cloud-based secure database. In some embodiments, the database of the PDHP system and method can be configured to be controlled by the patient (i.e., any data contained on or within the database is accessible and controlled by the patient). In some embodiments, access control can be provided using a secure authentication, (e.g., such as an authenticator structured to securely authenticate identity).

In some embodiments, the database of the PDHP system and method can be controlled by the patient and not a provider or insurance company. In some embodiments, the patient can decide which data to share with medical providers or medical insurance companies. In some embodiments, data records can be modified, such as address, while others can only be added with additional security clearance, such as a new prescription from a doctor. Subsequently, such records cannot be modified, but can be deleted. In some embodiments, data can also be made anonymous in compliance with HIPAA standards to allow for later statistical analysis of the collected health data.

In some further embodiments, access to the database of the PDHP system and method can be configured to be controlled by a legal guardian of the patient (i.e., any data contained on or within the database is accessible and controlled by the legal guardian). In some other embodiments, access to at least a portion of the database of the PDHP system and method can be controlled by someone, or some other entity, other than the patient. For example, in some embodiments, the database of the PDHP system and method can be controlled by a healthcare provider or insurance company, a medical practitioner or specialist.

In some embodiments of the invention, data stored in the database can include, but not be limited to, insurance identification information and eligibility, patient demographic information, name and address, self and family medical history, permission and release forms, list of drug and environmental allergies and sensitivities, healthcare directives and/or living will instructions, provider observational or diagnostic notes such as a SOAP (subjective, objective, assessment, and plan) note, and prescriptions (current, pending, past) with associated security tag (as described below). Further, the data stored in the database can include, but not be limited to, lab test results, such as blood tests, gait tests, EEG, ECG, respiration measurement, fitness records, such as heart-rate, weight, body fat, number of daily steps, sleep cycle, and data produced by biometric recording devices such as Fitbit, Inc., diet and nutritional journal medical images such as CT scans, MRI scans, x-rays, ultrasound, and completed questionnaires or surveys from providers, insurance, or other parties related to subjective measures of patient satisfaction, for example, surveys on patient satisfaction with the personal interactions at the doctor's office and perceived effectiveness of the prescribed treatment.

In some embodiments, it is possible to enter data through several sources. For example, in some embodiments, the patient can add records on their smartphone and/or tablet directly through the smartphone and/or tablet application using data entry sections within the PDHP system and method. For example, in some embodiments, the patient can go to the user information section to update current address. In some further embodiments, the patient can add records on their smartphone and/or tablet indirectly through third party applications that have been given permission to add records. For example, in some embodiments, a fitness tracking application can automatically enter a data record for today's number of steps walked. In other embodiments, the patient can add records through the web-based application using a web browser with secure login. This method can be especially useful when dealing with data that is more easily accessed from a computer. For example, in some embodiments, the patient can be able to use their doctor's existing patient portal to download their medical test results (e.g., such as a CT scan), and then use the PDHP system and method to upload the CT scan as a new record into the database. In some further embodiments, the provider can add records to the patient's database with permission from the patient through a request initiated from the provider's smartphone and/or tablet application. For example, in some embodiments, the provider can push a prescription to the patient.

In some embodiments, the provider can add records to the patient's database with permission from the patient through a request initiated from the provider's web-based application. In some embodiments, this method can be especially useful when dealing with data that is more easily accessed from a computer than from a handheld device. For example, in some embodiments, the patient can request past medical records from the provider, and the provider can retrieve and send these records through separate web-based applications.

In some other embodiments, the provider can add records to the patient's database with an automatic command sequence initiated by detection of the appropriate signal through the hardware interface unit 200. For example, when the patient's visit to the provider is complete, just before leaving the office, the patient can hold their smartphone and/or tablet in proximity to the hardware interface unit 200, which can initiate a chain of commands sending notes on the visit, vitals, and prescriptions to the patient's database.

In some embodiments of the invention, one or more medical records can be added automatically through parsing of third party databases, such as electronic health records, through interfaces programmed to activate from within the PDHP system and method when permission is given to access the third party database or the third party database asks for permission from the PDHP to receive data. For example, when an insurance database queries the PDHP system and method, the PDHP system and method can fill in missing data from the insurance database such as name, address, or insurance ID number.

Some embodiments of the invention include a patient smartphone and/or tablet application that can allow the patient to enter and retrieve records as well as to control settings allowing doctors, pharmacies and other health services to access certain components of the stored records. In some embodiments, the PDHP system and method can have features to prompt the patient for the data typically needed, such as address, health insurance information, and medical history. In some embodiments, rather than entering such data via paper forms, the PDHP system and method can provide individual questions on a screen-by-screen basis. Additionally, in some embodiments, the PDHP system and method can be tailored to only ask for data relevant to the patient, such as omitting questions about pregnancy if the patient is male.

In some embodiments, the PDHP system and method can also recall records from the database for viewing by the patient or their persons approved by the patient. In some embodiments, the PDHP system and method can contain a viewer for viewing stored medical images, such as CT scans. In some embodiments, the data can be stored in the cloud, and the database can be configured so that when the patient wishes to view the scan, the cloud server can return only image slices as dictated by gestures on the patient's phone/tablet.

In some embodiments, the PDHP system and method can be configured to communicate with other applications and features of the smartphone and/or tablet that can be able to add personal health records to the patient database. For example, in some embodiments, if the patient is using a fitness tracking application to keep track of the number of steps, heart-rate during workouts, or daily calories, the PDHP system and method application can send queries to the database to store the data as records.

In some embodiments, the PDHP system and method can also be configured to work with one or more existing calendar and email systems of the smartphone to interact with certain database records and issue reminders. Alternately, in some embodiments, the PDHP system and method can have its own calendar/messaging/task management features. For example, if a new record enters the database for a prescription issued by the doctor, the PDHP system and method can be configured to query whether the prescription has been filled. If not, a task can be sent to the patient, which appears on their smartphone and/or tablet, prompting them to get the prescription filled. Once the prescription is filled, the PDHP system and method can be configured to automatically set up calendar events to remind the patient to take their medication on time.

In some embodiments, the PDHP system can facilitate management of prescriptions providing an improvement over current methods used by most doctors (i.e., providing the patient a piece of paper with the prescription that they can take to the pharmacy). In some embodiments, when the doctor prescribes a medicine, the system can automatically add the prescription to the patient's medicine list in their database as a new medicine. In some embodiments, adding the medication as a new medicine can initiate automatic delivery of educational drug information to the patient, and also can attempt a reconciliation of the new medication with the patient's current medicines. That is, the system can look for possible unwanted interactions of the new medication with the other medications that the patient is currently taking, determine whether different medications can be taken simultaneously, and determine if the patient is taking the same mediation under two different names, etc. In some embodiments, appropriate messaging on such interactions can be sent to the patient and doctor. Also, internal timers in the application can be used for reminding the patient when to take medications, and can be adjusted for best effectiveness of the combined medications used by the patient.

In some embodiments, the PDHP system and method can also be configured to provide (e.g., on a display of a smartphone and/or tablet) an organized list of upcoming and past health-related events, such as doctor's appointments, prescriptions needing to be filled, post-treatment instructions, and other communications from healthcare providers. In some embodiments, the PDHP system and method can enable patients to manage, filter, and prioritize this list, and appropriate organization might be chronological in some embodiments. In some embodiments, filters can be by module, for example, setting a filter to show only health history when the patient is looking for particular events. In some embodiments, patient actions taken in this list can be automatically communicated through the PDHP system and method back to the provider as a means to determine whether further action is needed, for example, acknowledging if a pill has been taken.

In some embodiments, the patient web-based application can have many of the same features as the smartphone and/or tablet application, with the purpose of enabling an alternative pathway to access data. In some embodiments, the web-based application can use a standard computer with standard display. Since the display is much larger than the smartphone and/or tablet display, in some embodiments, it can be configured with more text or larger/more images accompanying dialogs to make data entry more intuitive. For example, in some embodiments, a DICOM viewer that can be used to view the patient's CT scan can only show a single slice plane on the patient's phone application, but can show three mutually orthogonal views on a web-based application running on a desktop computer. Additionally, the internet connection is typically faster on a desktop computer configured with Ethernet than on a smartphone and/or tablet configured with WiFi or 4G. Large pieces of data, such as multi-image scan series, can therefore be more easily uploaded to or downloaded from the patient database through the web-based application. A web-based application might also be preferred when the patient is retrieving data from other PC-based or web-based 3rd party applications since it can facilitate cutting and pasting of the data. In some embodiments, the web-based application can also take advantage of peripherals that are present on a desktop computer but not on a smartphone and/or tablet, such as a scanner.

Some further embodiments include a provider smartphone and/or tablet application that can allow healthcare providers to request certain records from the patient's database or send certain data to the patient's database. For example, if in the middle of an examination, the provider realizes they need a piece of data that exists on the patient's database, the provider can use their smartphone and/or tablet to send a request for that data to the database (e.g., such as a cloud database), which initiates a dialog with the patient's smartphone and/or tablet to accept or deny delivery of that data back to the provider. In some embodiments, the requested data can then be displayed on the provider's smartphone and/or tablet. In some embodiments, from the smartphone application, the provider can also provide messaging notification to the patient via the patient's smartphone and/or tablet/email or other means. In some embodiments, messaging to the patient can include, but not be limited to, notification of the waiting time before the appointment. In some embodiments, the provider or the provider's staff can send a message to the patient while in the waiting room to provide this notification if they are running behind schedule on the patient's appointment. In some embodiments, the notification can also be configured to occur automatically based on rules set up by the provider in their application, e.g., if greater than 30 minutes late for an appointment, issue notification.

In some embodiments, messaging to the patient can include notification of potential side effects of medication, risks associated with surgery, pre-operative procedures to follow or other medical information that the provider wishes to convey. In some embodiments, this information can be configured to be delivered automatically as a query to the patient's database based on the diagnosis, prescription, and surgical plan. In some further embodiments, messaging to the patient can include responses to frequently asked questions, with subsequent questions and responses dependent on responses that are already received. This method is discussed in more detail below.

In some embodiments, the provider's application is also an integral part of the delivery of prescriptions, described later in this document. In some embodiments, the provider's application can also enable features related to summarizing statistical data collected from databases of multiple anonymized patients as, for example, means and standard deviations. In some embodiments, these statistical summaries can be specific to a particular practice or accumulated from multiple practices. Examples of statistical data of interest to the provider and other parties (e.g., insurance provider) that can be drawn from database records include, but are not limited to, mean patient wait time, percentage of patient on-time arrival, mean patient-provider face-to-face time, prevalence of diseases treated, percentage of favorable patient outcomes, mean satisfaction values from completed surveys or questionnaires, provider web-based application.

In some embodiments, the provider web-based application can contain many of the same features as the provider smartphone and/or tablet application but instead can reside on a desktop computer through a resident program or webpage. In some embodiments, one purpose of a provider web-based application is to allow an alternate pathway other than the smartphone and/or tablet application for requesting patient data, sending patient data, and sending notifications to other staff or the patient. In some embodiments, this pathway can be more appealing in cases where the desktop computer has a larger screen and faster internet connection than the smartphone and/or tablet. Additionally, in some embodiments, it can be especially effective to utilize this pathway when interfacing with other applications that are resident on the desktop computer, and are not accessible through smartphone and/or tablet, for example, one of the many existing electronic health record systems.

In some embodiments of the invention, the web-based application can also be especially useful when desktop computers are utilized within a practice as “stations” that are available to multiple users. For example, in some embodiments, the web-based application can be configured to be running continuously in the testing lab within a practice. In some embodiments, different queries to the patient's database in which the doctor requests tests can send notifications to the test lab station in the practice to prompt the staff to collect and process samples and to send the results to the patient's database. In this way, the PDHP system and method can provide practice management features.

In some embodiments, the hardware interface unit 200 is a physical object or electronic device that can enable communication between the patient's phone and the database through wireless and/or wired means. In some embodiments, the hardware interface unit 200 can also enable communication with the patient's smartphone and/or tablet and the provider's smartphone and/or tablet through NFC (near-field communication), all forms of Bluetooth®, RF (radiofrequency), optical code reader, or other wireless communication, such that the user of the smartphone and/or tablet does not have to perform any gestures other than placing the phone in the vicinity of the hardware interface unit 200 to initiate communication and sequences of commands. In some embodiments, the hardware interface unit 200 can be an information or data recorder that can assist in reading or recording patient data or records from a medical practitioner. This information can be read to one or more digital files that can be distributed to the patient and/or other medical providers or practitioners. In some embodiments, the data can be read or recorded in the presence of the patient or not in the presence of the patient. Further, in some embodiments, the data can be read or recorded in the presence of the medical practitioner or not in the presence of the medical practitioner.

It should be clear that the term “hardware interface unit” can apply to a number of different options. In some embodiments, the “hardware interface unit” can be a QR code or optical bar code printed on a piece of paper, and taped to the countertop at the doctor's office, accessible to the patient where the patient can point the camera of their phone at the displayed code, thereby initiating commands according to software stored on the patient's phone. In some other embodiments, a more elaborate hardware interface unit can be a self-contained electronic processor that can read radio-frequency signals emitted from the phone or poll the phone or its case for stored electromagnetic information, and then process and transfer specific pieces of this information as needed according to software stored on the hardware interface unit itself.

Some embodiments include a hardware interface unit that provides a means for “logging in” or “logging out” of the PDHP system and method. That is, in some embodiments, when the patient enters the doctor's office, they can place their phone in the vicinity of the hardware interface unit, and the unit reads or enables transfer of some information from the phone. In some embodiments, this information can be a unique identifier, such as a string sequence previously associated with this particular patient. For example, FIG. 3A shows a front perspective view of a hardware interface unit 200 of a patient-owned electronic health records process PDHP system and method, and FIG. 3B shows a top-front perspective view of the hardware interface unit 200 of a patient-owned electronic health records process PDHP system and method. Further, FIG. 3C shows a front view of a hardware interface unit 200 of a patient-owned electronic health records process PDHP system and method, and FIG. 3D shows a side view of a hardware interface unit 200 of a patient-owned electronic health records process PDHP system and method. In some embodiments, the unit 200 can comprise a main housing 210 including an upper head 215 at one end extending from a support 225, and a base 230 at an opposite end extending from the support 225.

In some embodiments, the base 230 can comprise a support for information and/or a device, material, assembly and/or component to enable the information receiver 220 of the upper head 215 to receive information from the information and/or a device, material, assembly and/or component. In some embodiments, the base 230 can comprise an NFC reader. For example, as discussed earlier, in some embodiments, the hardware interface unit 200 can also enable communication with the patient's smartphone and/or tablet and the provider's smartphone and/or tablet through NFC (near-field communication), all forms of Bluetooth®, RF (radiofrequency), optical code reader, or other wireless communication. For example, in some embodiments, a user can place the phone in the vicinity of the hardware interface unit 200 to initiate communication and sequences of commands.

In some embodiments, the upper head 215 can include an information receiver 220 such as a QR code reader. During use, in some embodiments, the patient can hold their phone in roughly the same place whether using QR code reader (which looks down at the phone screen from above) or NFC reader (which senses the signals from below the phone). In some embodiments, a mini-computer (e.g., such as a Raspberry Pi® mini-computer) can be housed inside the base 230. Raspberry Pi® is a trademark of the Raspberry Pi Foundation. Some embodiments further include a fingerprint reader (not shown). Some further embodiments include one or more lights or illuminators. For example, some embodiments include lights 217 positioned on the upper head 215. In some embodiments, the lights 217 can comprise an LED light array. In some embodiments, the lights 217 can be positioned behind a cutout or logo in the hood. In some embodiments, the lights 217 can be controlled by the aforementioned mini-computer to show different colors and patterns that can indicate different functionality such as reading, transmitting, failed to read, etc.

In some embodiments, the information can comprise an optical reader, scanner or camera. In some embodiments, the optical reader, scanner or camera can be configured to optical scan, read, and/or image information supported on the base 230. For example, in some embodiments, the base 230 can support medical paperwork, medical scans, prescriptions, or patient health related information displayed on a cell phone or smart phone that can be read and/or received by the information receiver 220 using an optical reader, scanner or camera.

In some embodiments, the database for whatever patient's unique ID is read can be queried to determine if there is any data currently ready to be sent to the provider owning the hardware interface unit, such as patient name, address, and insurance information, recent vital statistics, etc. Although a similar initiation of data transfer can be made through other commands, such as a command sent from the patient's phone, the requirement of the phone being physically in the vicinity of the hardware interface unit can make it more likely that the patient is actually present in the doctor's office. It also makes it less likely for the patient's information to be sent to the wrong doctor's office. Similarly, in some embodiments, when the patient leaves the doctor's office, and they again place their phone in the vicinity of the hardware interface unit 200, the unique ID is read and the database is again queried to see if data is ready to be sent to the patient's database such as prescriptions, notes, or test results from the visit. In some embodiments, it can be advantageous for two different hardware interface units 200 to be accessed by the patient when they enter versus leave the provider's office. For example, in some embodiments, a different QR code can be placed near the exit and near the reception desk. Alternately, in some embodiments, the same hardware interface unit 200 can be used, and an algorithm employed to allow the system and method to distinguish between a patient entering or leaving an appointment. In this instance, the system can track the last time of interaction with the device, for example indicating that they must be leaving the appointment if it is greater than 10 minutes after the last interaction, but less than 5 hours from the previous interaction with the hardware interface unit 200.

In some embodiments, since someone other than the patient can be holding the patient's phone in the vicinity of the hardware interface unit 200, the patient's identity cannot be ensured simply from the unique ID that is read. Therefore, in some embodiments, the hardware interface unit 200 can also be equipped with additional means of identification for identifying the patient with a high level of certainty. In some embodiments, methods for identifying the patient with high certainty include, but are not limited to security code entry, digital encoding system such as QR or barcode, fingerprint matching, retinal pattern matching, facial recognition, voice recognition, and gait or gesture recognition, or other conventional secure identification method. In some embodiments, gait recognition refers to characterizing the patient's movement and comparing the pattern of movement to their previously stored pattern; gesture recognition can similarly be recognition of the pattern by which a person holds and interacts with a smartphone's screen or other implement. In some further embodiments, the hardware interface unit 200 can include gesture recognition, and can be configured to recognize one or more gestures from persons.

In some embodiments, the hardware interface unit 200 can also be equipped with built in features such as a keypad for entering a security code, fingerprint reader, retinal scanner, microphone for voice recognition, or a camera for facial or gait recognition. Alternately, in some embodiments, most of the security methods can be implemented through the patient's or provider's smartphone and/or tablet, such as usage of the smartphone's camera for facial or gait recognition, usage of the patient's or provider's smartphone and/or tablet for fingerprint scanning (if equipped), usage of the patient's or provider's smartphone's microphone for voice recognition, or usage of the patient's or provider's smartphone and/or tablet for entering the security code.

In some embodiments, since the primary way to communicate with the hardware interface unit 200 is through proximity, it is especially useful for initiating chains of events that require the patient to be physically present. That is, in some embodiments, when the patient places their phone in the vicinity of the hardware interface unit 200 when they check in for their doctor visit, the database can be queried to determine whether data that can be collected in the waiting room are required. If so, the hardware interface unit 200 can facilitate collection of these pieces of data, such as weight, temperature, or blood pressure as outlined below.

Some embodiments include electronic versions of the hardware interface unit 200 that are either a reader that feeds data directly into a computer, such as a desktop computer through USB interface, or the hardware interface unit 200 can itself include a self-contained microprocessor. Some advantages of providing a microprocessor on board the hardware interface unit 200 include, but are not limited to, using an on-board microprocessor, the hardware interface unit's functionality is not dependent on a separate host computer, which can be simultaneously running any number of other programs. In some embodiments, the security of the web communication can be controlled from the hardware interface unit 200, and is not susceptible to security breaches on a host computer. In some embodiments, the hardware interface unit 200 can be configured for each provider's office to allow or disallow a particular set of queries to the database. That is, in some embodiments, it can act as a filter or switch for data transfer between the provider and the patient's database. In some embodiments, the configuration of this filter can be controlled by the manufacturer of the hardware interface unit 200 to protect against potential misuse (intentional or unintentional), providing an extra layer of security.

In some embodiments, the hardware interface unit 200 can be configured for each provider's specialty or subspecialty for the purpose of custom forms management, database management, and functional EMR and practice management integration. In some embodiments, if the hardware interface unit 200 can simultaneously read and differentiate signals from two separate smartphones/tablets that are in its vicinity, another feature of the PDHP system and method is enabled, as discussed below, for using the provider's smartphone and/or tablet to confirm or tag as valid a prescription that is being sent to the patient's database.

Some embodiments include methods using the PDHP system and method, including, but not limited to, a narcotic prescription method. Currently, by law, narcotics must be prescribed in writing, signed by the prescribing doctor, and cannot be phoned in to the pharmacy. In some embodiments, the method can be facilitated where a doctor can create a secure electronic prescription through the components of the PDHP system and method.

In some embodiments, the prescription is created electronically by the doctor, nurse, or physician's assistant using the smartphone and/or tablet application or web-based application configured for a prescribing provider. When configured for a prescribing provider, sections of the PDHP system and method and application are activated that may not be active for non-prescribing providers, specifically, prescription form and prescription templates. Some embodiments include two potential sequences of steps for transferring the prescription to the patient's database. For example, in some embodiments, a provider can hold the provider's smartphone and/or tablet and the patient's smartphone and/or tablet simultaneously in proximity to the hardware interface unit 200. In some embodiments, the hardware interface unit 200 can be configured such that only when a provider's smartphone and/or tablet with ready prescription and a patient's smartphone and/or tablet with identification matching the ready prescription are both present will it push the prescription to the patient's database along with a software security tag. If any of these requirements are missing, prescription transfer fails. That is, the following requirements must be met: both smartphones/tablets must be simultaneously present, or must be present sequentially within a certain window of time such as 5 seconds, and the provider's phone/tablet must have a ready prescription matching the identification of the patient's phone.

In some embodiments, the patient can hold their phone in proximity to the provider's hardware interface unit 200, after which the unit prompts the patient for secure biometric identification including, but not limited to, fingerprint, retina scan, and facial recognition. In some embodiments, after verifying identity, the PDHP system and method can push the prescription to the database via a secure web connection, and the prescription can be tagged with a software security tag. In some embodiments, once the prescription is electronically tagged to show that it has been validated by the physician and has been entered into the patient's database, the patient can have the prescription filled at a pharmacy by holding their smartphone and/or tablet in proximity to a hardware interface unit 200 that is at the pharmacy. In some embodiments, the hardware interface unit 200 at the pharmacy can query the patient's database to determine if an unfilled prescription with appropriate security tag is present. If so, in some embodiments, the PDHP system and method can request secure biometric identification of the same format that was required at the doctor's office, and if the identity is confirmed, the prescription can be filled. In some embodiments, this type of system can be more secure than conventional systems requiring a paper prescription for narcotic drugs because it can be less susceptible to fraud.

There can be cases in which the patient is incapacitated and is unable to fill their own prescription. In such cases, the PDHP system and method can be queried so that a fingerprint transfer to their designated agent (e.g., spouse, parent, child) is authorized. In some embodiments, to enable a fingerprint transfer, the fingerprint or other biometric information can be pre-stored on the database. In some embodiments, the database can store, for example, fingerprints of multiple family members, then at the time the prescription is authorized according to the above method, the patient can be prompted to select which family members can be authorized to fill the prescription. The authorized party can then be able to use their own smartphone and/or tablet at the pharmacy to notify the PDHP system and method of the new prescription as described above, and their own fingerprint can be requested for authorization by the PDHP system and method instead of the patient's. Similarly, in some embodiments, a retina pattern or facial pattern can be stored and authorized for designated agents to fill prescriptions if those methods can be used for authorization.

Typically, a patient's vitals are collected at the doctor's office by the staff such as a physician assistant. Vitals can include, but are not limited to, blood pressure, temperature, weight, height, heart-rate, electrocardiogram, electromyogram, blood oxygenation, and blood glucose level. These vitals can be collected when the patient enters the back office, before entering the exam room or after entering the exam room but before the doctor sees the patient. In some embodiments, one or more of the vitals mentioned above can be collected semi-automatically using the PDHP system and method and the hardware interface unit 200. Such an automated procedure can speed up the throughput of the office, and can simplify aspects of the medical office staff's job, including the manual process of collecting vitals, the process of storing the vitals, and the process of transferring the vitals to the patient. A sequence of steps for this method can include the following: In some embodiments, when the patient taps their phone/tablet on the hardware interface unit 200 at the doctor's office, the patient can be identified and if conditions are met, such as a scheduled visit is underway, an automatic query is sent to the database, requesting certain vitals that are specific to that doctor's office and that patient's condition. In some embodiments, on receiving the query, the database signals the patient's phone/tablet, and a dialog appears on the phone/tablet to guide the patient through the process of collecting vitals. In some embodiments, the patient can receive instructions on collecting vitals through equipment in the office that is wireless. For example, in some embodiments, the patient can be instructed on their phone to attach the wireless blood pressure cuff to their arm. In some embodiments, when attached, the patient can answer a dialog on the phone. In some embodiments, the phone can communicate with the hardware interface unit 200, which can initiate collection of data from the blood pressure cuff. In some embodiments, when data is available from the blood pressure cuff, the hardware interface unit 200 pushes the data to the patient's database as a new database entry. In some embodiments, the PDHP system and method can repeat the third step for each vital that can be collected in this manner. In some embodiments, the patient can feel uncomfortable collecting data in this manner or can wish for assistance from the staff. Therefore, in some embodiments, the patient can answer the dialog on their phone/tablet with a “decline” response when prompted to collect vitals from the medical equipment.

Some embodiments include vitals such as weight, represent information that can have been collected at home earlier in the day before the doctor visit. In some embodiments, any piece of information that has been been collected previously can be queried automatically by the PDHP system and method at the time the patient taps their phone/tablet to the hardware interface unit 200. In some embodiments, if the information is already present in the patient's database within an acceptable time window relative to the time of the appointment, the PDHP system and method can retrieve that information, mark it as complete, and skip guiding the patient through that collection. Each doctor's office should be able to configure the queries sent by their PDHP system and method to select which vital statistics, if any, they can allow the patient to collect unsupervised.

Some benefits of collecting vitals in this way before entering the exam room include that the patient is more relaxed because they are in a more comfortable setting, and/or the patient is more relaxed because they have not been waiting long, and parents might be able to control their children more easily in a setting like this. In some embodiments, the data can be more reliable because of the relaxed environment in which it is taken. In some embodiments, the new data can be appended to prior measurements and displayed immediately in a format allowing easy comparison to prior measurements.

In some embodiments, rather than dealing with multiple pieces of hardware such as a separate blood pressure cuff, thermometer, and pulse measurement unit, a customized “all-in-one” vital collection device can be used that can form part of the PDHP system and method. In some embodiments, this device can have a similar form factor to a blood pressure cuff, and similar to an automatic blood pressure cuff, can have the necessary components for measuring blood pressure, including, but not limited to, an inflatable sleeve, an inflation mechanism, a pressure sensor, a microphone for listening for blood noises, and a microprocessor for recording and calculating blood pressure based on pressure observed during different noises while the cuff pressure decreases. However, in some embodiments, the unit can also be configured so that the microphone can simultaneously or sequentially be used for listening for regular heartbeats and recording pulse. Additionally, in some embodiments, the unit can be fitted with a finger-attached optical and thermal sensor to enable measurement of skin temperature and blood oxygenation. In some embodiments, the patient can attach the device to their arm and sit down to wait while it collected blood pressure, pulse, temperature, and/or blood oxygenation without any user input. In some embodiments, when complete, the PDHP system and method can notify the patient through a push notification to their phone that the device can be removed.

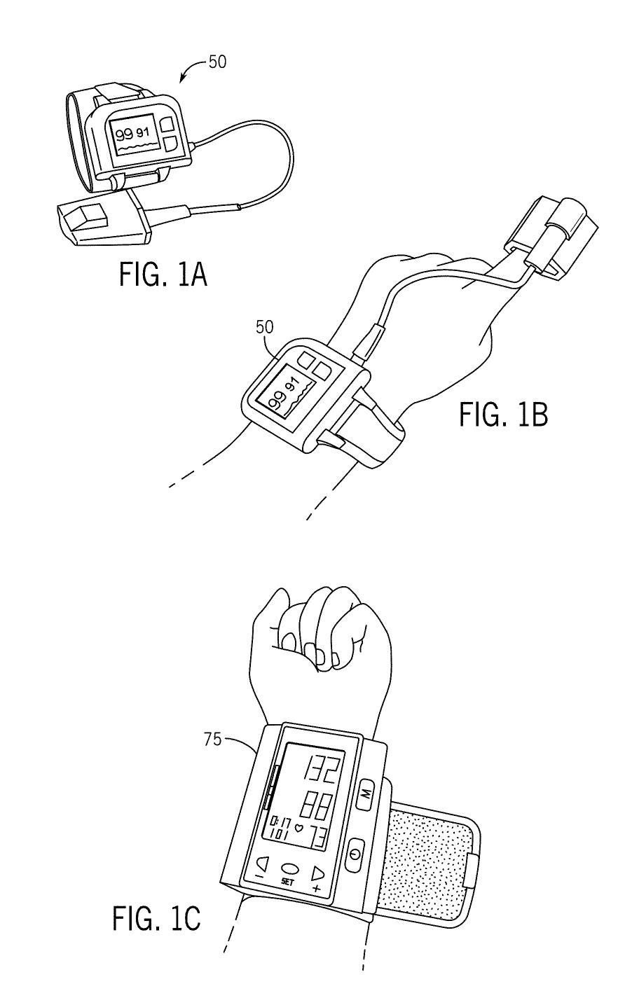

Some embodiments of the PDHP system and method can measure multiple vitals from the same unit, including, but not limited to, blood pressure, temperature, weight, height, heart rate, electrocardiogram, electroencephalogram, electromyogram, blood oxygenation, and blood glucose level. For example, FIG. 1A illustrates an all-in-one device 50 according to some embodiments of the invention, and FIG. 1B illustrates a wrist-mounted all-in-one device 50 of FIG. 1A according to some embodiments of the invention. Further, FIG. 1C illustrates a wrist-mounted all-in-one device 75 that includes a blood-pressure cuff according to some embodiments of the invention. In some embodiments, the all-in-one devices 50, 75 can combine a pulse oximeter. Other embodiments include a fingerprint reader/pulse oximeter. Since fingerprint reading is already necessary as a means for authenticating that the patient's identity is correct, in some embodiments, the same device can also be used for measuring pulse and blood oxygenation either simultaneously or sequentially. In some embodiments, such a device can have internal lighting that is adjustable for low intensity, necessary for detecting the fingerprint image, and high intensity, necessary for testing the transmission of light through the fingertip for the pulse oximeter. Functionally, in some embodiments, the patient can place their finger in the unit and can be instructed to leave it there until both the pulse oximeter's readings and the fingerprint sensor's readings are successfully recorded.

Fingerprint readers are not exclusively optical. For example, there are also ultrasound-based methods for detecting fingerprints (e.g., from Sonavation, Inc, 3970 Rca Blvd #7003, Palm Beach Gardens, Fla. 33410). If an ultrasound-based or other non-optical system were to be used for fingerprint detection, the combination fingerprint/pulse oximetry sensor can still be feasible. For example, some embodiments include a hybrid system that can have a housing with a stationary portion in which the patient inserts their finger, and a non-stationary portion containing both sensors (optics-based pulse oximeter and ultrasound-based fingerprint detector). In some embodiments, a linear or rotational drive mechanism can move each sensor into appropriate position under the fingertip to allow each sensor to be used without the patient lifting their finger off the unit.

In some embodiments, when the patient interacts with the doctor, a dialog occurs through which the doctor asks the patient questions to try to get to the root of the problem. For example, if the patient says they are having postoperative discomfort, the doctor can try to determine whether they are following the postoperative instructions, asking whether the patient filled the prescription for the pain killers and asking whether the patient is taking the correct dosage. If not, the patient is instructed to take the medication correctly; if so, the doctor asks more questions to try to “drill down” to the reason for the problem. In some embodiments, a PDHP system and method can set up an automated response tree that helps the patient drill down to the desired information automatically without interacting with the doctor but using information provided by the doctor. Such a system can help the patient reach an answer to their problem more quickly than if they have to wait for an opportunity to interact with the doctor, and save the doctor the time required to have a dialog with the patient that can be unnecessary.

In some embodiments, the PDHP system and method can be a decision tree, with different answers to questions at higher levels guiding the dialog through different branches of questions at lower levels. For example, in some embodiments, possible answers must be anticipated and used to build the branches of the decision tree. Some embodiments include a user-friendly PDHP system and method for constructing the tree in which the provider is prompted to provide questions and potential answers, after which the tree is graphically built with different colors or icons indicating incomplete branches.

In some embodiments, unanticipated responses or reaching the end of the tree without resolution of the problem can be configured to automatically return a response indicating to the patient that they should contact the provider. In some embodiments, branches leading to a potentially severe health hazard can be configured to notify the patient to seek emergency medical attention and notify the provider of the hazard. In some embodiments, pre-built decision trees can be made available for providers who have not yet contemplated their own decision tree. The provider can then modify or add to the decision tree. Additionally, in some embodiments, the decision tree builder can be set up to learn and expand over time. For example, in some embodiments, if the tree is set up with branches to handle a question to the patient of whether they have “a) symptom 1, b) symptom 2, or c) other” and the patient answers “c) other”, the PDHP system and method can automatically ask the patient to enter the unanticipated response. In some embodiments, the PDHP system and method can then send the provider a query indicating where the decision tree failed and what the alternate answer was, and prompting the provider to expand the tree to handle this response.

In some embodiments, when a user adopts the PDHP system and method, they can set up their own data entry layout and their own printable form layout. These items are set up using one of the following methods: In some embodiments, one or more forms are selected from a set of available forms, retrievable from a database via a secure cloud, and the software can be used to build a custom form. Some embodiments include software features that can allow the selection of the desired fields from available fields, creation of new fields that do not yet exist, rewording of prompting questions for available fields (e.g., “Home address” vs. “where do you live?), and selection of the order of fields within the form and sequential order when asked on the smartphone, tablet, or computer. In some embodiments, after setting up the forms and data entry layout, the PDHP system and method can enable the forms and data entry layout to be previewed as it appear to the patient and office staff. In some embodiments, after finalizing, the PDHP system and method can enable the form and data entry attributes to be associated with the QR code or other practice identification method such as near field communication. In some embodiments, the QR code and form attributes can be stored together on the secure cloud for updating as needed and for controlling access to data by the practice (i.e., data that is not included in their selected queries is filtered).

In some embodiments, at some time after establishing the desired form content, the user (e.g., a medical practitioner) can decide that additional information is needed. For example, the practitioner may have forgotten to include certain relevant questions, or a new public health issue can arise. For example, in some embodiments, if a new virus that was previously rare becomes prevalent, a practice may want to add a question about the new illness (e.g., as Zika virus is starting to be seen in cities where it has not appeared before, a practitioner may want to ask patients “have you ever been tested for the Zika virus?”). In some embodiments, the PDHP system and method can enable the request for the new question/data field through the secure cloud, via the practitioner's smartphone/tablet or desktop interface. In some embodiments, the new question can be immediately added to the data layout of that practice over the secure cloud using the same methods that were used to add new questions at the time the forms were first created. Further, in some embodiments, when a practice inserts an additional question to their data structure and forms, they can elect to keep this new question as a private selection, available only to their own practice, or they can elect to make it public. In some embodiments, if public, the PDHP system and method can automatically (or with approval from a controller) push a notification to other practices asking if they would be interested in adding the question to their own data structure and forms. In some embodiments, with a simple “yes” response, the forms and data structure for the responding practice can be updated.

Some embodiments include a PDHP system and method that can perform automatic management of database fields available to different practices as potential entries for their forms based on statistical usage of the fields. In some embodiments, the PDHP system and method can adapt automatically so that when new practices join, the most popular form questions are suggested first. Some practices may wish to have unique or obscure questions on their forms that would not generally be of interest but must still be maintained by the software management company. The practice may wish to restrict certain questions from being placed on the list of choices for other practices to consider. However, even obscure questions can become part of the list of choices of potential fields for new practices, although they would be prioritized to be offered at the bottom of the list, which can be ordered from most popular at the top to least popular at the bottom. In some embodiments, as certain new questions become more popular with practices for their forms, they move up on the list. In some embodiments, when a certain threshold is reached where enough practices think a question is valuable, the PDHP system and method can send out a push communication to all the member practices suggesting that it can be of use to add to their own questionnaire.

In some embodiments, access to data in the PDHP system and method can be controlled by the patient, not the doctor or insurance company. In some embodiments, the access can be allowed over a limited time period. In some embodiments, when the patient checks in for an appointment through a secure identity check at the doctor's office (e.g., possibly including smartphone assistance), that interaction signals the beginning of permission to the doctor to access the records allowed by the patient on the secure cloud. In some embodiments, when the patient checks out through another interaction such as a computer software dialog, QR code read, or NFC interaction, the access permission ends. In some embodiments, if the patient's records are updated during the time the doctor's office has permission to access them (for example, another specialist enters their notes on a relevant complication), then the doctor's office can access the changed records seamlessly, and the new data can be attached, and it can immediately become visible. Essentially, the doctor's office has access to a snapshot of the last data that was available up until permission ended. In some embodiments, if the patient wishes to allow permission for the doctor to view certain data on an extended or permanent basis, they can control which pieces of data should be accessible in the event that these data fields change after the explicit permission period ends. For example, in some embodiments, the patient may wish for the doctor to know the outcome of pending test results, but may not wish for the doctor to know the outcome of every future test of the same type. For this example, some embodiments would be limited extended permission.

Other types of permission can be allowed by the PDHP system and method that follow different rules dictated by the patient. For example, in some embodiments, the patient may wish for their primary doctor to know whenever they get a new prescription from any specialist in case the drug has unwanted interaction with other prescriptions. In such a case, the patient might give permanent extended permission to certain doctors to view and be actively updated when these new prescriptions enter the patient's database. In some embodiments, the patient would have selected an option that any data that satisfies the description of new prescription would be automatically filtered and processed by the PDHP system and method as it enters the database. Some embodiments include filtering rules that can be set such that the new data is automatically packaged and sent out as an email, instant message, or special data packet recognizable by the primary care doctor.

In some embodiments, the PDHP system and method can allow an automated method for entering prescription information. In this method, the patient can take a photo of the label on a standard pharmacy-issued pill bottle or case. In some embodiments, using optical character recognition, the PDHP system and method can automatically interpret the printed information from the label and parse the information into the appropriate fields, including, but not limited to date of prescription, drug name (brand and generic), dosage, prescribing physician, name of pharmacy, condition treated, and/or cost of drug. In some embodiments, this information can then be uploaded to the secure cloud as a data point in the patient's database.

In some embodiments, some data stored in the patient's database can, in its raw form, be unusable by the patient. For example, lengthy postoperative reports written in abbreviations and medical jargon may not be comprehensible by the patient. In some embodiments, these reports can be kept present in the patient's database since there may be nuggets of information that can be useful to the patient if properly reformatted. In some embodiments, the PDHP system and method can include processes to automatically extract such information from items currently stored in the patient database, reformat them, and enter the reformatted summary as a new entry in the database. For example, it may be of interest for the patient to summarize when they previously exhibited a certain symptom. Such information can be buried in the doctor notes, lab test results, and other places within their database. In some further embodiments of the invention, the PDHP system and method can enable software features to search through the patient's database looking for key terms indicating the symptom in question. In some embodiments, a timeline can then be built that is clickable and that shows all of the instances of the symptom in a graphical format. In some embodiments, this timeline can be added to the database as a new data point. In some embodiments, the PDHP system and method can enable automatically updating of this timeline in the event that new data matches the search terms.

Another relevant example of this type is tracking of healthcare costs. Since cost is often associated with different pieces of data such as prescriptions, co-pays, over-the-counter drugs, emergency room, and other data points, in some embodiments, some data in the patient's database for all of these items can include a cost field, but not all the data would be in the same category. In some embodiments, the PDHP system and method can automatically run filters and summaries of key pieces of information queried from the database that can be extracted and reformatted in a meaningful way. With cost, it is especially important to know how much cost has been expended toward the deductible for budgeting purposes and ensuring that the insurance provides correct benefits. In some embodiments, this type of filter, can become a new data point in the database, and can be dynamic in that every time the patient looks at the summary, it is automatically updated with a fresh PDHP system and method query to collect and summarize any new data that may have arrived.

Some embodiments include summarizing data to filter the text from reports in the database and to turn ICD10 codes, for example, into natural language that is more meaningful to the patient. The codes written in the doctors' and insurance companies' reports can consist of numbers, acronyms, and abbreviations, but in some embodiments, the PDHP system and method can translate this information into a more understandable format and store the translation as a new data entry.

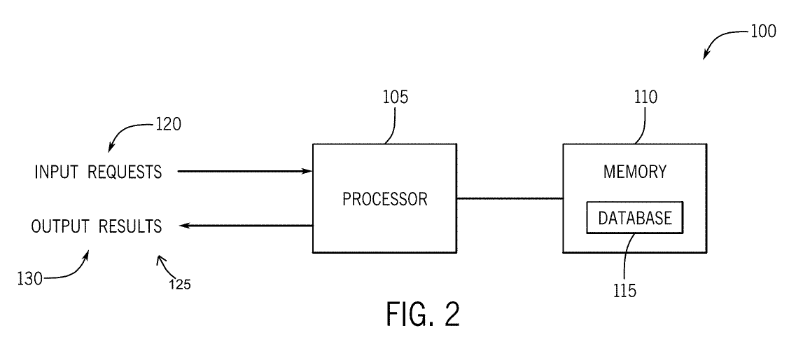

Some embodiments include one or more computer systems of the PDHP system and method. In reference to FIG. 2, some embodiments include a block diagram of a system 100 implementing one or more patient-owned electronic health records processes of at least one embodiment of the above described PDHP system and method. In some embodiments, the system 100 can includes a processor 105 coupled with a memory 110, where the memory 110 configured to store data. In some embodiments, the processor 105 can be configured to interface or otherwise communicate with the memory 110, for example, via electrical signals propagated along a conductive trace or wire. In an alternative embodiment, the processor 105 can interface with the memory 110 via a wireless connection. In some embodiments, the memory 110 can include a database 115, and can include a plurality of data or entries stored in the database 115 of the memory 110.

As discussed in greater detail herein, in some embodiments, the processor 105 can be tasked with executing software or other logical instructions in order for the price transparency medical procedure search to function as desired. In some embodiments, input requests 120 can be received by the processor 105 (e.g., via signals transmitted from a digital gateway 125 of a user at a remote system or device, such as a handheld device like a smartphone or tablet, to the processor 105 via a network or internet connection). In an alternative embodiment, the input requests 120 can be received by the processor 105 via a user input device that is not at a geographically remote location (e.g., via a connected keyboard, mouse, etc. at a local computer terminal). In some embodiments, after performing tasks or instructions based upon the user input requests 120, for example, looking up information or data stored in the memory 110, the processor 105 can output results 130 back to the user (through the digital gateway 125) that are based upon the input requests 120.

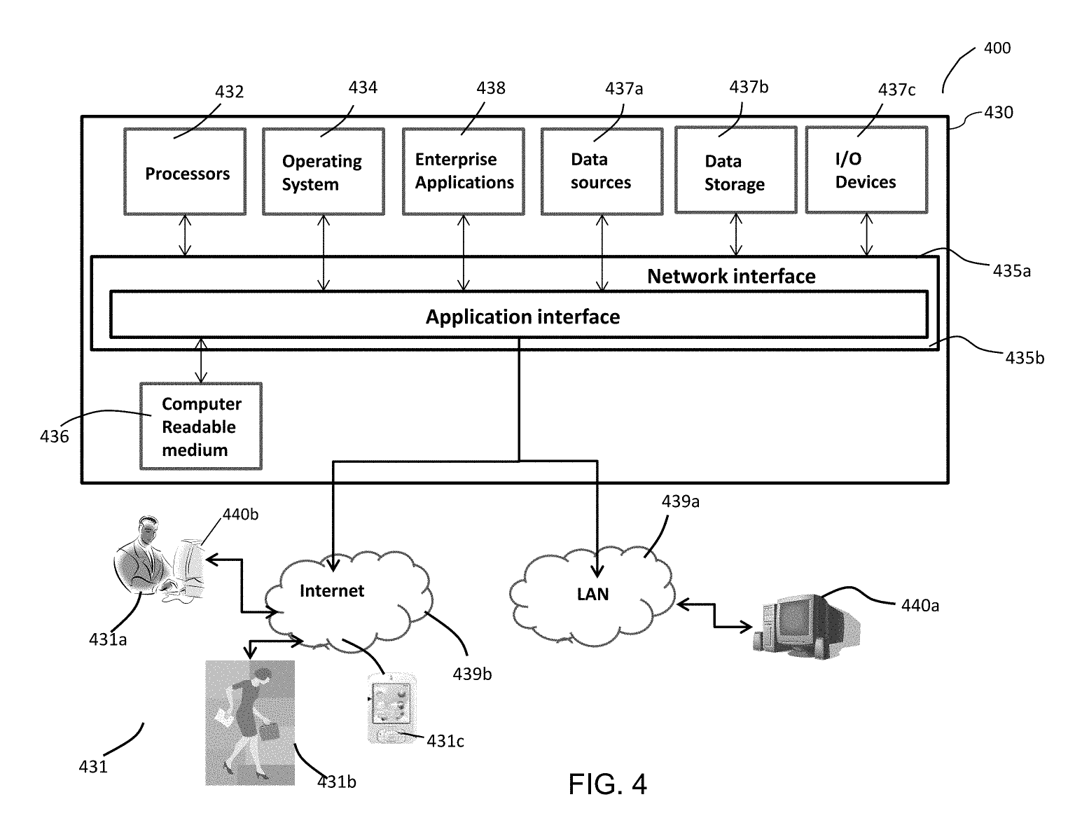

In some embodiments, the one or more components of the system 100 can be can comprise or be coupled to the system 400 as shown in FIG. 4 illustrating a computer system 400 configured for operating and processing components of the systems and methods described herein. In some embodiments, the computer system 400 can process one or more software modules of the aforementioned systems and methods, and can be configured to display information related to or produced by any of these systems and method using one or more graphical user interfaces. Further, in some embodiments, the computer system 400 to process one or more system and method application services. In some embodiments, the system 400 can manage the organization of data and data flow between the system and method application services, front end systems, and external (third party) computer systems and databases comprising or coupled to the system 400.

In some embodiments, the system 400 can comprise at least one computing device including at least one processor 432. In some embodiments, the at least one processor 432 can include a processor residing in or coupled to one or more server platforms. In some embodiments, the system 400 can include a network interface 435a and an application interface 435b coupled to the least one processor 432 capable of processing at least one operating system. Further, in some embodiments, the interfaces 435a, 435b coupled to at least one processor 432 can be configured to process one or more of the software modules (e.g., such as enterprise applications 438). In some embodiments, the software modules 438 can operate to host at least one patient account, and operate to transfer data between the patient account and one or more other accounts of the patient and/or accounts owned by a health care provider (e.g., such as a doctor) using the at least one processor 432. In some embodiments, either one or both interfaces 435a, 435b can comprise a digital gateway for transfer and/or exchange of patient related information and patient data. In some embodiments, the digital gateway can host at least one patient account, and operate to transfer data between the patient account and one or more other accounts of the patient and/or accounts owned by a health care provider (e.g., such as a doctor).

In some embodiments of the invention, the system 400 can comprise at least one computer readable medium 436 coupled to at least one data source 437a, and/or at least one data storage device 437b, and/or at least one input/output device 437c. In some embodiments, the invention can be embodied as computer readable code on a computer readable medium 436. In some embodiments, the computer readable medium 436 can be any data storage device that can store data, which can thereafter be read by a computer system (such as the system 400). In some embodiments, the computer readable medium 436 can be any physical or material medium that can be used to tangibly store the desired information or data or instructions and which can be accessed by a computer or processor 432. In some embodiments, the computer readable medium 436 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 436 can transmit or carry instructions to a computer and/or at least one user 431, including a router, private or public network, or other transmission device or channel, both wired and wireless. In some embodiments, the software modules 438 can be configured to send and receive data from a database (e.g., from a computer readable medium 436 including data sources 437a and data storage 437b that can comprise a database), and data can be received by the software modules 438 from at least one other source. In some embodiments, at least one of the software modules 438 can be configured within the system to output data to at least one user 431 via at least one graphical user interface rendered on at least one digital display.

In some embodiments of the invention, the computer readable medium 436 can be distributed over a conventional computer network via the network interface 435a where the system embodied by the computer readable code can be stored and executed in a distributed fashion. For example, in some embodiments, one or more components of the system 400 can be coupled to send and/or receive data through a local area network (“LAN”) 439a and/or an internet coupled network 439b (e.g., such as a wireless internet). In some further embodiments, the networks 439a, 439b can include wide area networks (“WAN”), direct connections (e.g., through a universal serial bus port), or other forms of computer-readable media 436, or any combination thereof.

In some embodiments, components of the networks 439a, 439b can include any number of user devices such as personal computers including for example desktop computers, and/or laptop computers, or any fixed, generally non-mobile internet appliances coupled through the LAN 439a. For example, some embodiments include personal computers 440a coupled through the LAN 439a that can be configured for any type of user including an administrator. Other embodiments can include personal computers 440b coupled through network 439b. In some further embodiments, one or more components of the system 400 can be coupled to send or receive data through an internet network (e.g., such as network 439b). For example, some embodiments include at least one user 431 coupled wirelessly and accessing one or more software modules of the system including at least one enterprise application 438 via an input and output (“I/O”) device 437c. In some other embodiments, the system 400 can enable at least one user 431 to be coupled to access enterprise applications 438 via an I/O device 437c through LAN 439a. In some embodiments, the user 431 can comprise a user 431a coupled to the system 400 using a desktop computer, and/or laptop computers, or any fixed, generally non-mobile internet appliances coupled through the internet 439b. In some further embodiments, the user 431 can comprise a mobile user 431b coupled to the system 400. In some embodiments, the user 431b can use any mobile computing device 431c to wireless coupled to the system 400, including, but not limited to, personal digital assistants, and/or cellular phones, mobile phones, or smart phones, and/or pagers, and/or digital tablets, and/or fixed or mobile internet appliances.

In some embodiments, the system 400 can enable one or more users 431 coupled to receive, analyze, input, modify, create and send data to and from the system 400, including to and from one or more enterprise applications 438 running on the system 400. In some embodiments, at least one software application 438 running on one or more processors 432 can be configured to be coupled for communication over networks 439a, 439b through the internet 439b. In some embodiments, one or more wired or wirelessly coupled components of the network 439a, 439b can include one or more resources for data storage. For example, this can include any other form of computer readable media in addition to the computer readable media 436 for storing information, and can include any form of computer readable media for communicating information from one electronic device to another electronic device.

Some embodiments include an application on the smartphone or tablet (e.g., computing device 431c) that can be customized through software. For example, some embodiments include one or more customized data filters. In some embodiments, the hardware interface unit 200 can be customizable and can be set to allow interactions that are unique to a given medical specialty. In some embodiments, this customization can be achieved through software, hardware, or firmware. For example, in some embodiments, when the patient checks in with the smartphone application, the hardware interface unit 200 and/or software interface can filter data from the patient's database such that the data appearing on the provider's application are specific to their specialty (e.g., orthopedics, neurology, physical medicine and rehab, physical therapy, cardiology, OBGYN, Internal Medicine, etc.).

As described earlier, in some embodiments, the hardware interface unit 200 can be a physical object or electronic device that can enable communication between the patient's phone (e.g., computing device 431c) and the database through wireless or wired means. Further, as described earlier, the hardware interface unit 200 can also enable communication with the patient's smartphone and/or tablet and the provider's smartphone and/or tablet through NFC (near-field communication), RF (radiofrequency), optical code reader, or other wireless communication, such that the user of the smartphone and/or tablet does not have to perform any gestures other than placing the phone in the vicinity of the hardware interface unit 200 to initiate communication and sequences of commands. Another form of communication that is covered by “other” can be Bluetooth®, including Bluetooth®, Low Energy (BLE).

In some embodiments, the addition of records or other commands to the PDHP system can be initiated by proximity of the patient's smartphone or tablet to one or more hardware interface units. For example, a practice can have three hardware interface units 200 in their office, including one at the front desk, one in the examination room, and one at the checkout desk. In some embodiments, commands relevant to the location can be initiated by proximity to each hardware interface unit 200. In some embodiments, the patient can touch the smartphone or tablet to a hardware interface unit 200 or the unit can sense the phone's proximity without requiring any interaction. Then, for example, in some embodiments, when the patient is closest to the hardware interface unit 200 at the front desk, commands relevant to checking in, scheduling appointments or other administrative tasks can be automatically initiated or can populate a pared-down menu on the patient's smartphone or tablet. In some embodiments, when the patient is closest to the examination room's hardware interface unit 200, commands relevant to medications, symptoms, medical and family history and continuation of care document can be automatically initiated or can populate a selective menu on the smartphone or tablet. In some embodiments, when the patient is closest to the hardware interface unit 200 at the checkout desk, commands relevant to payment, prescriptions and follow-up appointments can be auto-initiated or can populate a selective menu on the smartphone or tablet.

In some embodiments, instead of using multiple hardware interface units and sensing proximity to specific devices to initiate different actions, more sophisticated GPS or RFID technology known as “Geo-Fencing” can define boundaries that reflect the actual floor plan of a practice, or specific areas where patients will walk. In some embodiments, when patients cross into different geo-fenced regions as sensed using GPS or RFID, different actions are initiated as described in the previous paragraph.

In some embodiments, the patient's smartphone or tablet application can be configured to track a number of different health parameters, as was described earlier. Some further embodiments include tracking of headaches including migraines into the application by the patient. For example, some embodiments include data tracking of headache severity, location, precursory conditions, duration, attempted treatment, and/or effectiveness of treatment that can be recorded and automatically stored in the patient's database. In some embodiments, this data can then be reported by the patient's database to the clinic dashboard. In some other embodiments, in addition to raw data, data from the patient can be filtered by various means including, but not limited to, statistical functions that can calculate average headache days, total number of headache hours in a month, and average intensity (scale 1-10). In some embodiments, such filtering can make the data less qualitative and more quantitative, and can provide an improved metric to the provider for the effectiveness of ongoing treatment (medication management and effectiveness as an example).

In some embodiments of the invention, in addition to recording and summarizing migraine headache data, the application can build a predictive model for migraines to facilitate early intervention in treatment of migraines. In some embodiments, the predictive model can include patient data such as day of menstrual cycle, stress level, number of hours of sleep, etc., and can also include environmental factors independent of the patient. For example, in some embodiments, whenever the temperature rises 7 degrees over 70 degrees within a 48 hour period, the model can reflect an increased risk of migraine based on published research or research gathered automatically by the application and system. In another embodiment, a predictive factor can be the consideration that each time the barometric pressure goes up or down relative to the previous day, the risk of a headache increases.

In some embodiments, combining environmental factors, current state of health, and history, the predictive model can provide useful predictive information that can be meaningfully conveyed to the patient. For example, in some embodiments, if a patient has reported a headache over three days, where the temperature was above 90 degrees, and the barometric pressure was above 25 in Hg at 2 PM, the model can predict that the patient may have a headache today at 2 PM based on the weather, pollen (time of year) and barometric pressure, all of which have trended up. In some embodiments, when conditions, symptoms, and history fit the model above a certain threshold, the application can warn the patient that they are at high risk for a migraine and the patient can take precautions such as ensuring that they will be in a comfortable setting and being more vigilant about taking medication at the first signs of migraine onset.

In some embodiments, the application can communicate with weather and other environmental apps and programs to utilize data that are specific to a patient's health issues. In some embodiments of the invention, the application can have a customizable function such as a “My Health Impacted by Weather” function. In some embodiments, when the user activates this function, environmental conditions that are relevant to their health issues can trigger warnings. For example, if it is known that migraines are more likely to occur with high pollen, and when high pollen is predicted through a pollen reporting application linked to the healthcare application, the patient can receive a warning of high pollen. Similarly, if it is known that a low-changing-to-high barometric pressure is associated with higher likelihood of migraine, then when such a pressure change occurs and is monitored by a weather application, this data is read by the healthcare application and the patient can be warned that they are at risk for a migraine. In some embodiments, if the patient knows they are less impacted by certain factors than others, they can set the software to ignore warnings about the less relevant factors. For example, in some embodiments, if a patient knows that high pollen does not affect their migraines even though it generally affects migraines of others, the patient can set the software to skip warnings for pollen.

Smart phones and tablets have accelerometers and other internal devices to measure the position of the device, and are commonly used to sense whether the phone is being held sideways and if so, to rotate the screen. In some embodiments, the accelerometer built a phone can be used by the application to measure range of motion of different joints. For example, in some embodiments, the user can press a button when ready, hold the phone in their hand, and move their arm in a motion described or pictured in the software while the phone measures the angular range of motion of the joint and stores it to the patient's database. In some embodiments, for measuring range of motion of the lower limbs, the application can be configured to instruct the user to place the phone in the patient's sock or otherwise strap it to their limb. In some embodiments, the smart phone can be used to measure ranges of motion of a number of joints, including, but not limited to, shoulder rotation, elbow or knee flexion and extension, ankle flexion, extension, pronation, and supination, back or neck flexion, extension, axial rotation, and lateral bending. In some embodiments, the data collection can be prompted by the application then automatically stored in the patient's database. In some embodiments, at a later time, any relevant data can be conveyed to a physical therapist or other medical personnel to provide information useful in understanding progress in treatment and healing.

In some embodiments, the smartphone/tablet application, coupled with the internal mechanisms of the smartphone/tablet device or coupled with custom or 3^{rd} party wearable exercise tracker (FitBit, Nike, Garmin, Apple, etc.), can be used to monitor compliance. For example, in some embodiments, the phone and/or exercise tracker can record the number of cycles of walking or other movement, and show whether a patient appears to be performing their physical therapy exercises after discharge from a surgical procedure. In some embodiments, additional features or “rules” can be customized in the application by the healthcare provider and patient to help encourage the patient to comply with doctor's orders. For example, in some embodiments, if a certain number of steps are not seen by a certain time of day, the application can issue a pop-up reminder to the patient or play a recording for the patient to remind them to do the exercise. In some embodiments, when the patient sees the doctor in a follow-up visit, the compliance can be summarized on the clinician dashboard, providing valuable information to help tailor the recovery plan.

In some embodiments of the invention, the clinician dashboard for summarizing and organizing patient data can be customized from a view standpoint based on specialty. In embodiments, the physician can pick a standard view based on what is typical for their specialty, for example, oncology, orthopedic surgery, etc. to view the information driven by the data from the patient application. In some embodiments, physicians can then create “viewer profiles” that can allow them to change the layout of their dashboard view based on their personal desire to include information not on the typical layout, which in some embodiments, can help drive clinical decision making. For example, in some embodiments, the surgeon can be interested in particular symptoms, activities, diet, etc. that they personally have seen to be influential, but are not generally considered by the mainstream medical community.

In some embodiments, the PDHP system can provide information through the smartphone application to help the user organize medicines and understand interactions and dosages, and remind the patient when it is time to take medication. Additionally, in some embodiments, the system can act as a smart reference for the patient, where the patient clicks through a sequence of questions and answers to describe the symptoms and history of the onset, after which the system suggests the most appropriate medication for the patient to take based on rules set up in the system by the doctor. In some embodiments, the system can also learn from past success or failure of different medicines in treating the patient's symptoms and select which medicine works best for the patient.

In some embodiments, in addition to being an aid in selecting correct medication and reminding which medication to take, the smartphone/tablet and PDHP system can interface with another custom microprocessor-based device that acts as a physical dispenser of the medication.

In some embodiments, the patient or their caregiver can pre-fill separate chambers in the dispenser device with different medications, and when the system determines that it is time for a dose to be dispensed, a command can be sent to the dispenser through a Wi-Fi, direct connection, Bluetooth®, and/or other means that can cause actuators in the dispenser to open a door, drawer, or other feature to dispense a dose of the correct medication to the patient.

In some embodiments, the PDHP system can be set up to auto-build and refine statistically-based models for predicting onset of symptoms or best treatment options for different diseases. For example, in some embodiments, about 100 different factors can be identified that may or may not be associated with the onset of symptoms of a disease. In some embodiments, after a few events have been recorded with severity of symptoms and intensity of each factor, the system can look for a relationship between symptoms and factors, performing analysis of variance, analysis of covariance, product moment correlations or other statistical tests to determine which factors appear to have good predictive ability. In some embodiments, some factors may not correlate with symptom onset at all, whereas others may appear to contribute slightly, and others may contribute greatly. In some embodiments, if the factors were used to create a model for predicting onset of symptoms, each factor can be given a different weight, with factors not predicting symptoms at all being weighted zero, and factors that reliably predict symptoms being weighted more strongly. In some embodiments, as time goes by, and more events are collected, the weightings can change and the model can produce a different outcome if used to predict whether symptoms are going to occur for a patient. In some embodiments, if the model is “trained” with historical data from only one patient, it can be very good at predicting onset of symptoms for that patient. In some embodiments, if the model is trained with historical data from an array of patients, it can be good at predicting onset of symptoms in the general patient or a new patient for whom no data has yet been collected.

In some embodiments of the invention, when a doctor or other medical provider uses the PDHP system to view the patient's medical images, the system can provide a means for recording information about the images. In some embodiments, the doctor can be provided with tools to allow with a simple click or gesture for an image to be marked with an indicator such as “read”, “good”, “bad”, “needed”, etc., and to circle or highlight areas of interest on images. In some embodiments, these markings can make it easier for the doctor to look at the images later and remember features about them or know whether they have already been reviewed. In some embodiments, after these indicators have been marked, the system can record in an associated database entry that the doctor marked the image in this way on this date, thus allowing the patient and other doctors to later more easily interpret the same images, and to have a more complete record of when a particular doctor looked at a particular image.

In some embodiments, the PDHP system can provide valuable assistance during telemedicine episodes both on the patient side and on the provider side (e.g., such as when patients are unable to leave home or late at night). In such a case, the patient can seek help through telemedicine by calling in to a telemedicine service via telephone, video call, or computer chat. In some embodiments, the PDHP system can provide a “script” and “decision tree” for the medical professional taking the call, who may be a physician assistant, medical student, or other professional who is knowledgeable about the patient and their disease but not at the same expert level as the patient's regular doctor. In some embodiments, the expert doctor can have the script set up on the PDHP system in advance. During the call, the assistant can be enabled to follow the decision tree, asking the next question appropriately depending on how the patient responds. As the assistant goes through the script and follows the decision tree, they can be enabled to click on the patient responses to get the next scripted question. By interfacing this way, the assistant can create a clear log of the event and the path down the tree that can later be traced to understand what was happening when the patient had the emergency. In some embodiments, on the patient side, the application can have buttons and software features making it easier for the patient to initiate the telemedicine call, and providing them with customized visual aids that the medical professional may need to show in explaining the disease or treatment. Additionally, in some embodiments, the smartphone can be used to take photos or video of the patient to provide to the medical professional with images of lesions or other relevant features.

After completing a visit in the doctor's office, a common method for sending the SOAP (subjective, objective, assessment, and plan) note and CCR (continuity of care record) to the EMR, insurance, another doctor, or patient is via fax. In some embodiments, the PDHP system can include a software-based “fax engine” that can enable the system to receive fax communications and automatically upload the faxed information into the patient's database. In some embodiments, the fax engine can receive faxes to the patient's own phone number with an extension since fax machines commonly have the ability to dial a number, pause, then dial a second number. In other embodiments, the smartphone application can manage how calls are received, and can filter calls that are from specific phone numbers known to the PDHP system, such as the doctor's fax machine, and route those incoming calls to the fax engine without causing the phone to ring. In some embodiments, the patient's phone can also be used as the source for outgoing faxes to doctors, EMRs or other parties needed the medical information in fax format. Additionally, in some embodiments, fax transmission and receipt can be triggered by the user placing their smartphone in proximity to the hardware interface unit 200. That is, in some embodiments, when the user checks out of the office by placing their smartphone near the hardware interface unit 200, the hardware interface unit 200 can send a signal back to the phone preparing it to send or receive a fax if needed. In some embodiments, the transmission of medical information to the patient's health portfolio as described earlier in this document can occur entirely through fax instead of Wi-Fi if desired.

In some embodiments, with the fax engine in place as part of the PDHP system, patients can further build information in their health portfolio by requesting their healthcare providers, medical testing labs, pharmacies and other sources of medical information to fax copies of healthcare documents to their personal phone number. In some embodiments, if the user receives an incoming call from a fax machine and hears the fax “chirp” sound, they can launch the fax engine by touching the application for the PHDP system. In other embodiments, the PDHP system application can run continuously, listening for the fax chirp and taking over the call when it hears a fax tone. In other embodiments, if the user enters or is given the fax number of the doctor, lab, or pharmacy before the doctor faxes the information to their phone, the system can be prepared that if it receives a phone call from that number to send it directly to the fax engine and not to try to answer it as a voice call.

In some embodiments, the application can operate in a limited visibility mode for soliciting second opinions or other situations where sharing medical images with several individuals is important but access should be limited to maintain privacy. In some embodiments, the limited visibility mode can be similar to Snapchat in social media where images are available for an invited doctor to review, but where the doctor would not be able to open the same images a second time (without permission). Additionally, in some embodiments, the doctor can only look at images up to a certain limited time, but after the time period expires, they can lose permission to view the images even if they have not yet viewed them at all.

In some embodiments, the system can be set up with a 911 emergency application requiring important medical information about the patient in case of emergency in a situation where the patient is incapacitated but they have their phone on their person. In some embodiments, this functionality can appear as a menu choice when launching the PDHP application, or can be an entirely separate application with an easy-to-find button on the patient's phone that can be accessed without unlocking the rest of the phone. That is, most phones are password protected or set up with some unlocking mechanism such as fingerprint scan or swipe pattern. In some embodiments, an emergency application can be set up in such a way that it can be accessed by persons other than the phone's owner without the person knowing the phone's main password but instead by entering a special emergency password (i.e., “9-1-1”) on the unlocking screen.

In some embodiments, once an emergency application is launched, it can require a code only available to qualified caregivers such as EMTs, doctors, nurses, or other professional healthcare providers to prevent unauthorized access to any information. In some embodiments, it can require secondary information that can only be obtained from the owner of the phone, such as facial recognition, fingerprint, or a series of questions about the patient like “what gender? What hair color? What eye color?”, intended to prove that someone else is using the patient's phone to help them while they are incapacitated. In some embodiments, once the caregiver enters the medical emergency unlocking code, they can have access to any crucial information for the patient's care. For example, if a user was on vacation skiing and had an accident, the emergency personnel can launch the emergency application to see if the patient is allergic to any medications, is diabetic, has a heart condition, etc.

In some embodiments, another method to incorporate an emergency access method is for the patient to carry a card in their wallet or have a sticker on their phone with a code and website, or have the phone display code and website when anyone tries to unlock the phone incorrectly or when launching the emergency app. In some embodiments, the card or message on the phone can tell an emergency provider to go to a website (for example, http://mindsetmedical.provider.com/911) and enter the code. When they do, they can be prompted to enter their UPN number or other identifier indicating that they are a qualified medical caregiver. In some embodiments, the website can provide the necessary medical information about the patient. Additionally, in some embodiments, the emergency application can automatically alert the patient's spouse or other emergency contact person about the GPS location of the phone, and that the emergency application has been accessed.

When a patient leaves the doctor's office after they have received a new prescription, they are typically given or directed to look through a selection of small-print detailed educational materials that they can read before starting treatment. In some further embodiments of the invention, instead of a patient passing by an “info board” with this reading material in paper form, the system can allow the patient to walk through the “info board area” assisted by a message on their smart device and/or by the medical assistant who advises the patient to “swipe” their smart device over a branded pharmaceutical “tag” such as a QR code or NFC label for the prescribed medicine. In some embodiments, upon the swipe, the user can be prompted with useful patient educational material for reference while on-boarding the newly prescribed drug or device.

In another example embodiment where a patient is considering having surgery or is seeking a second opinion, without going through formal registration as a patient for the doctor, they can be prompted by the medical assistant to swipe or aim their smart device for pre-operative education, typical follow up, and practice-specific instructions to enable them to learn what different doctors might do differently in these aspects of care. In another example embodiment, the system can provide improved follow-up and education after emergency room visits.

In some embodiments, one or more of the systems and methods described herein can provide manageable chunks of information as push notifications spread out over time, delivered at pertinent times, and containing aspects of two-way dialog to ensure that the patient understands what they are reading. For example, a notification could say “you are now in day 2 after your event. Typical symptoms at this point include A, B, C. Do you have any of these symptoms? These are normal. Symptoms to watch out for are D, E, F. Do you have these?” If the patient confirms an undesirable event, the system can put them in touch with an emergency telemedicine doctor or an office assistant to schedule a follow-up appointment.

In another example embodiment, a patient can be prompted to download an application related to patient education once they enter the office, or at any time. In some embodiments, this prompting could occur by proximity detection such as Bluetooth® or GPS, or WiFi. In some embodiments, the user can be prompted by the system in a push notification fashion, with a message appearing on their smart device stating that an educational app is being made available to them to download.

Some medical treatments such as Botox injections, pharmaceutical companies have a mail-in or web-based process to determine whether the patient qualifies for treatment. In some embodiments, the system can allow an easier method where a kiosk with a puck-sized hardware device provided by the pharmaceutical company could be present, or other interface method such as a QR code along with a message stating “touch or point your phone here to see if you qualify for Botox treatment.” In some embodiments, the system can gather information from the patient's database as allowed according to permissions set in the application, and possibly excluding some patients with this step and providing a message on the smart device in some embodiments. In some embodiments, then the application can prompt the patient to answer a series of questions streamlined by using each response to narrow the range of the next question so that the qualification for treatment can be determined quickly and easily. Finally, in some embodiments, if the patient qualifies for treatment, the application and database can streamline getting an appointment and transferring files to the treating doctor.

In some embodiments, systems and methods described earlier can help to provide improved guidance on dosage to prevent opioid abuse. In some embodiments, if a patient picks any of the current narcotic prescriptions in their medication module, the system can automatically request the patient log their pain at a specific time every night (6 pm for example). In some embodiments, at the scheduled time, a window can open on their device asking the patient to rate their pain and reminding them to take the indicated number of pills. In some embodiments, the window can block other use of the smart device until the dialog is answered. In some embodiments, based on their response to level of pain and the input from our medical advisory board, the system can adjust the length of time and number of pills that a patient would be told to take, attempting to gradually decrease intake and to try to wean them off of the medication.

In some embodiments, in addition to logging of pain, such as headache, through the applications and systems described herein, an additional component can include emergency monitoring. For example, in some embodiments, when a patient logs a series of consecutive pain incidents (e.g., five incidents) over a five day period at an extremely severe level, a pop-up can prompt the patient to seek immediate medical attention with a physician or an emergency center. In some embodiments, the application can help connect them to a provider based on our informed network.

In a similar way to how the application and system can track migraine headaches, the application and system can also track back pain, as was described earlier. For example, in one non-limiting example embodiment, the patient can use a phone to measure range of motion for their back through the app, as described earlier. Additionally, when logging pain through the application, if the patient is in so much pain that they cannot get out of bed, they can indicate that they need to be “seen” as soon as possible. In some embodiments, the system (e.g., a smart phone) can initiate a phone call, (e.g., preferably via video call on the phone inside the application), can be made to allow visual observation by the telemedicine doctor. As described earlier, in some embodiments, the doctor receiving the call can see the patient's medical history, medications, symptoms, etc. before accepting the “call”. In some embodiments, the patient can be pre-screened, and can then have a brief visit on the phone with a spine specialist who then can direct physical therapy, pain management, etc. In some embodiments, when treating new patients through telemedicine, the liability can be managed, which can be facilitated by thorough logging of the call, questions, and responses. Moreover, moving across state lines can also be an medical-legal issue, and the use of the patient's smart device's GPS can tell the system whether state lines are an issue on the telemedicine call.

With the above embodiments in mind, it should be understood that the invention can employ various computer-implemented operations involving data stored in computer systems. Moreover, the above-described databases and models throughout can store analytical models and other data on computer-readable storage media within the system 400 and on computer-readable storage media coupled to the system 400. In addition, the above-described applications of the system can be stored on computer-readable storage media within the system 400 and on computer-readable storage media coupled to the system 400. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. Further, any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A personal digital health portfolio system comprising;
a computer system including at least one processor and at least one coupled source of patient medical records or patient data, the computer system including at least one secure authenticator structured to securely authenticate identity of at least one first entity as an uploader, downloader or reviewer of the patient medical records or patient data;
at least one non-transitory computer-readable storage medium in data communication with the processor, the at least one non-transitory computer-readable storage medium configured for securely storing and exchanging data related to the content of or the accessibility of the patient medical records or patient data;
an application programming interface (API) in data communication with the processor and the at least one non-transitory computer-readable storage medium, the application programming interface including steps executable by the processor for uploading, downloading, or enabling accessing of patient medical records or patient data stored on the at least one non-transitory computer-readable storage medium; and
an interface of the source of patient medical records or patient data, the interface configured to read and transfer the patient medical records or patient data under control of a second entity via the application programming interface (API); and
a digital gateway coupled to provide distributed access of the patient medical records or patient data stored from the at least one non-transitory computer-readable storage medium to at least one doctor, pharmacy, health service, or insurance company, wherein the distributed access is maintained, controlled or provided by the first or second entity for specific components of patient medical records or patient data that form the personal digital health portfolio.

2. The system of claim 1, wherein the interface of the source is a hardware interface.

3. The system of claim 2, wherein the hardware interface comprises a main housing including an upper head at one end extending from a support, and a base at an opposite end extending from the support.

4. The system of claim 3, wherein the main housing includes an optical reader, scanner or camera.

5. The system of claim 3, wherein the main housing includes a wireless receiver configured to enable wireless transfer of instructions or data from a smartphone or tablet.

6. The system of claim 5, wherein the wireless receiver comprises at least one of a near-field communication receiver, an RFID receiver, a WiFi receiver, a Bluetooth, and a Bluetooth Low Energy (BLE) receiver.

7. The system of claim 2, wherein the interface comprises at least one information or data recorder configured and arranged to assist reading or recording of at least one record of at least one medical practitioner relating to the at least one patient, to at least one digital file, wherein at least a portion of the digital file is transferable through the digital gateway.

8. The system of claim 7, wherein the at least one information or data recorder is configured to read or record information obtained by at least one of a medical practitioner in the physical presence of at least one patient, a medical practitioner not in the physical presence of the patient, at least one patient in the presence of at least one medical practitioner, the patient not in the presence of at least one medical practitioner, or substantially simultaneously information from the patient and the medical practitioner.

9. The system of claim 1, wherein at least one of the first entity and the second entity is the patient.

10. The system of claim 1, wherein at least one of the first entity and the second entity is a doctor or insurance provider.

11. The system of claim 1, wherein the at least some of the steps comprise steps of at least one application program interface (API) executed on a smartphone or tablet.

12. The system of claim 11, wherein the smartphone or tablet comprises the interface.

13. The system of claim 11, wherein the interface is configured and arranged to read data from the smartphone or tablet.

14. The system of claim 11, wherein the interface includes an optical reader configured to enable imaging of a screen of the smartphone or tablet.

15. The system of claim 11, wherein the interface includes a wireless receiver configured to enable wireless transfer of instructions or data from the smartphone or tablet.

16. The system of claim 15, wherein the wireless receiver comprises at least one of a near-field communication receiver, an RFID receiver, a WiFi receiver, a Bluetooth, and a Bluetooth Low Energy (BLE) receiver.

17. The system of claim 1, wherein the interface comprises a device measuring one or more health or medical parameters directly from the patient.

18. The system of claim 17, wherein the device comprises at least one of a blood-pressure monitor or cuff, heart-rate monitor, accelerometer, a wearable exercise tracker, a body temperature tracker, a patient weight tracker, a patient height tracker, an electrocardiogram tracker, an electroencephalogram tracker, an electromyogram tracker, a blood oxygenation tracker, and a blood glucose level tracker.

19. The system of claim 1, wherein the patient medical records or patient data comprises at least one of insurance identification information and eligibility, patient demographic information, patient name and address, patient medical history, patient family medical history, permission and release forms, list of drug and environmental allergies and sensitivities, healthcare directives and/or living will instructions, provider observational or diagnostic notes including at least one of subjective, objective, assessment, and plan notes), and prescriptions including at least one of current, pending, and past with an associated security tag, lab test results including at least one of blood tests, gait tests, EEG, ECG, and respiration measurement, fitness records including at least one of heart-rate, weight, body fat, number of daily steps, sleep cycle, diet, and medical images including at least one of CT scans, MRI scans, x-rays, ultrasound, and questionnaires or surveys from providers, insurance, or other parties related to subjective measures of patient satisfaction including at least one of patient satisfaction with the personal interactions at the doctor's office and perceived effectiveness of the prescribed treatment.

20. The system of claim 1, wherein the interfaces supports or controls a secure login to at least one account associated with the patient of at least one medical practitioner or medical provider on an intranet or internet website.
